(19) United States
(12) Patent Application Publication
(10) Pub. No.: US 2024/0230949 A9
(43) Pub. Date: Jul. 11, 2024

(54) GRAVIMETER ZERO-DRIFT CORRECTION METHOD, APPARATUS AND ELECTRONIC DEVICE

(71) Applicants: Wang Zhang, Qingdao (CN); Beihai Offshore Engineering Survey Institute, SOA, Qingdao (CN)

(72) Inventors: Wang Zhang, Qingdao (CN); Xiaowei Shi, Qingdao (CN); Ruyuan Bu, Qingdao (CN); Hongchao Wang, Qingdao (CN); Kaixiang Cao, Qingdao (CN); Yaming Liu, Qingdao (CN)

(21) Appl. No.: 18/463,232

(22) Filed: Sep. 7, 2023

(30) Foreign Application Priority Data
Oct. 24, 2022 (CN) 202211305944.0

(51) Int. Cl. G01V 13/00; G01V 7/02

(52) U.S. Cl. CPC G01V 13/00; G01V 7/02

(57) ABSTRACT

The present application discloses a gravimeter zero-drift correction method, apparatus and electronic device, which belongs to the field of gravimeter correction. The gravimeter zero-drift correction method includes: acquiring standard comparison data and actual monitoring data of the gravimeter; determining a plurality of difference values between the actual monitoring data and the standard comparison data; determining the presence or absence of an inflection point among a plurality of difference values; correcting a plurality of difference values in the absence of inflection point among a plurality of difference values; correcting difference values on both sides of a demarcation point respectively by taking an infection point as a demarcation point, in the presence of an inflection point among a plurality of difference values.

### CROSS-REFERENCE TO RELATED APPLICATIONS

This application claims priority of Chinese Patent Application No. 202211305944.0, filed on Oct. 24, 2022, the entire contents of which are incorporated herein by reference.

### TECHNICAL FIELD

The present application belongs to the field of gravimeter correction, and specifically discloses a gravimeter zero-drift correction method, apparatus and electronic device.

### BACKGROUND

With the development of science and technology, an increasing number of exploration is conducted targeting the ocean. For example, the ocean is explored through ships' ocean-going. In the process of ship's ocean-going, the ship is installed with a gravimeter which is used to conduct real-time monitoring. However, the gravimeter usually has a zero drift, i. e., the presence of a difference value between the gravimeter reading acquired from the gravity base point comparison measurement of the gravity's first leaving from the dock and the last returns to the dock, and such difference value is a zero drift. In order to use the gravimeter more accurately, the gravimeter zero drift needs to be corrected. According to the related technology, when gravimeters zero-drift correction is performed, the accuracy of the correction is generally low.

### SUMMARY

Examples of the present application are aimed to provide a gravimeter zero-drift correction method, apparatus and electronic device that can solve the problem of the low accuracy of the general correction when gravimeter zero-drift correction is performed.

In a first aspect, examples of the present application provide a gravimeter zero-drift correction method, characterized in that, the correction method includes:
acquiring standard comparison data as well as actual monitoring data of a gravimeter;
determining a plurality of difference values between the actual monitoring data and the standard comparison data;
determining the presence or absence of an inflection point among the plurality of difference values;
correcting the plurality of difference values in the absence of an inflection point among the plurality of difference values; and
correcting a difference value on both sides of the demarcation point respectively in the presence of an inflection point among the plurality of the difference values.

Optionally, the determining the presence or absence of an inflection point among the plurality of difference values, including:
comparing the magnitude of a target difference value and difference values on both sides of the target difference value, wherein the target difference value is any difference value among the plurality of difference values other than the difference values at two endpoints;
if difference values on both sides of the target difference is greater than or less than the target difference, there is an inflection point among a plurality of the difference values and the target difference is an inflection point;
if only one of difference values on both sides of the target difference value is greater than the target difference value and the other difference value is less than the target difference value, there is no inflection point among a plurality of the difference values.

Optionally, the correcting the plurality of difference values in the absence of an inflection point among the plurality of difference values, including:
Correcting the plurality of difference values according to a correction formula in the absence of an inflection point among a plurality of the difference values, where the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, the correcting difference values on both sides of the demarcation point respectively by taking the infection point as a demarcation point, in the presence of an inflection point among the plurality of difference values, including:
correcting difference values on both sides of the demarcation point respectively in the presence of an inflection point among a plurality of the difference values;
correcting a difference value between the two infection points by taking each infection point as a demarcation point, in the presence of a plurality of inflection points among a plurality of the difference values, and correcting a difference value between an inflection point closest to an endpoint among a plurality of the difference values and the endpoint.

Optionally, the correcting difference values on both sides of the demarcation point respectively, including:
Correcting difference values on both sides of the demarcation point respectively according to a correction formula, wherein the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, the correcting a difference value between the two infection point, including:
correcting a difference value between the two inflection points according to a correction formula;
the correcting a difference value between an inflection point closest to an endpoint among a plurality of the difference values and the endpoint, including:
correcting a difference value between an inflection point closest to an endpoint among a plurality of the difference values and the endpoint according to a correction formula, where the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, the difference value corresponds to a time point, and before determining the presence or absence of an inflection point among the plurality of difference values, the correction method further includes:
determining whether a plurality of time points corresponding to the plurality of difference values are continuous;
determining the presence or absence of an inflection point among the plurality of difference values in a case that the plurality of time points are continuous;
determining the presence or absence of an inflection point for the plurality of difference values on both sides of the intermittent time period in the presence of an intermittent time period among the plurality of time points.

Optionally, in the presence of an intermittent time period among the plurality of time points, the correcting difference values on both sides of the demarcation point respectively by taking the infection point as a demarcation point, in the presence of an inflection point among the plurality of the difference values, including:
standardizing a plurality of difference values on both sides of the intermittent time period so that standards for a plurality of difference values at both ends of the time period are the same;
determining location of the inflection point relative to the intermittent time period;

In a case that the inflection point is located on the same side of the intermittent time period, correcting difference values on both sides of the inflection point by taking the inflection point as a demarcation point.

In a second aspect, examples of the present application provide a gravimeter zero-drift correction apparatus, characterized in that, the correction apparatus includes:
an acquisition module, configured to acquire standard comparison data and actual monitoring data of an gravimeter;
a first determination module, configured to determine a plurality of difference values between the actual monitoring data and the standard comparison data;
a second determination module, configured to determine the presence or absence of an inflection point among the plurality of difference values;
a first correction module, configured to correct the plurality of difference values in the absence of an inflection point among the plurality of difference values; and
a second correction module, configured to correct difference values on both sides of the demarcation point respectively in the presence of an inflection point among the plurality of the difference values.

Optionally, the second determination module, including:
a comparison unit, configured to compare the magnitude of a target difference value and difference values on both sides of the target difference value, where the target difference value is any difference value among the plurality of difference values other than the difference value at two endpoints;
a first determination unit, for the case that if each of difference values on both sides of the target difference value is greater than or less than the target difference value, there is an inflection point among a plurality of the difference values and the target difference value is an inflection point;
a second determination unit, for the case that if only one of difference values on both sides of the target difference value is greater than the target difference value and the other difference value is less than the target difference value, there is no inflection point among a plurality of the difference values.

Optionally, the first correction module, configured to:
Correct the plurality of difference values according to a correction formula in the absence of an inflection point among the difference values, where the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, the second correction module, configured to:
correcting difference values on both sides of the demarcation point respectively in the presence of an inflection point among a plurality of the difference values;
correcting a difference value between the two infection points by taking each infection point as a demarcation point, in the presence of a plurality of inflection points among a plurality of the difference values, and correcting a difference value between an inflection point closest to an endpoint among a plurality of the difference values and the endpoint.

Optionally, a second correction module, configured to:
Correcting difference values on both sides of the demarcation point respectively according to a correction formula, wherein the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, the second correction module, configured to:
correcting a difference value between the two inflection points according to a correction formula;
the correcting a difference value between an inflection point closest to an endpoint among a plurality of the difference values and the endpoint, including:
   correcting a difference value between an inflection point closest to an endpoint among a plurality of the difference values and the endpoint according to a correction formula, where the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ Indicates the time of pre-measurement base point comparison, t₁ indicates the time of pre-measurement base point comparison, t indicates the time of a measurement point.

Optionally, the difference value corresponds to a time point, and the correction apparatus further includes:
a third determination module, configured to determine whether a plurality of time points corresponding to the plurality of difference values are continuous;
a fourth determination module, configured to determine the presence or absence of an inflection point among the plurality of difference values in a case that the plurality of time points are continuous;
a fifth determination module, configured to determine the presence or absence of an inflection point for the plurality of difference values on both sides of the intermittent time period.

Optionally, in the presence of an intermittent time period among the plurality of time points, the second correction module, configured to:
standardize a plurality of difference values on both sides of the intermittent time period so that standards for a plurality of difference values at both ends of the time period are the same;
determine location of the inflection point relative to the intermittent time period;

In a case that the inflection point is located on the same side of the intermittent time period, correct difference values on both sides of the inflection point by taking the inflection point as a demarcation point.

In a third aspect, examples of the present application provide an electronic device, and the electronic device includes a processor and a memory, where the memory stores a program or an instruction runnable on the processor, where the step of the method according to the first aspect is implemented when the program or the instruction is executed by the processor.

In a fourth aspect, examples of the present application provide a readable storage medium, where the readable storage medium stores a program or an instruction, where the step of the method according to the first aspect is implemented when the program or the instruction is executed by a processor.

In a fifth aspect, examples of the present application provide a chip, where the chip includes a processor and a communication interface, where the communication interface is coupled with the processor, and the processor is used for running a program or an instruction to implement the method according to the first aspect.

In a sixth aspect, examples of the present application provide a computer program product, and the program product is stored in a storage medium, and the program product is executed by at least one processor to implement the method according to the first aspect.

In examples of the present application, acquire standard comparison data and actual monitoring data of the gravimeter, determine a plurality of difference values between actual monitoring data and standard comparison data, determine the presence or absence of an inflection point among a plurality of difference values, correct a plurality of difference values in the absence of an inflection point among a plurality of difference values, correct difference values on both sides of a demarcation point respectively by taking an infection point as a demarcation point in the presence of an inflection point among a plurality of difference values. That is, in examples of the present application, by acquiring actual monitoring data of the gravimeter, determine a plurality of difference values between actual monitoring data and standard comparison data afterwards, and determine the presence or absence of an inflection point among a plurality of difference values, and correct difference values on both sides of a demarcation point respectively by taking an infection point as a demarcation point in the presence of an inflection point to implement more accurate zero drift correction for a gravimeter.

### BRIEF DESCRIPTION OF THE DRAWINGS

FIG. 1 is a flow chart of a gravimeter correction method provided by examples of the present application;

FIG. 2 is a schematic diagram of the difference value between actual monitoring data and standard comparison data of a gravimeter provided by examples of the present application;

FIG. 3 is a schematic diagram of the difference value between actual monitoring data and standard comparison data of a gravimeter provided by examples of the present application;

FIG. 4 is a schematic diagram of a gravimeter correction apparatus provided by examples of the present application;

FIG. 5 is a schematic diagram of an electronic device provided by examples of the present application;

FIG. 6 is a schematic diagram of a hardware structure of an electronic device provided by examples of the present application.

### DETAILED DESCRIPTION OF EMBODIMENTS

The technical solutions in examples of the present application will be clearly described below in conjunction with the drawings in examples of the present application, and it is clear that the example described is a part of examples of the present application, and not all of them. Based on examples of the present application, all other examples acquired by an ordinary person skilled in the art fall within the scope of protection of the present application.

The terms “first”, “second”, etc. in the specification and claims of the present application are used to distinguish similar objects and are not intended to describe a particular order or sequence. It should be understood that the data used hereby can be interchanged as appropriate, so that examples of the present application can be implemented in an order other than those illustrated or described herein, and the objects distinguished by “first”, “second”, etc. are generally of one type and the terms do not limit the number of objects. For example, the number of a first object can be one or more. In addition, “and/or” in the specification and the claims indicates at least one of the connected objects, and the character “/”, generally indicates an “or” relationship between the interrelated former and latter objects.

The gravimeter correction method provided by examples of the present application is described in detail below by means of specific examples and their application scene in conjunction with the drawings.

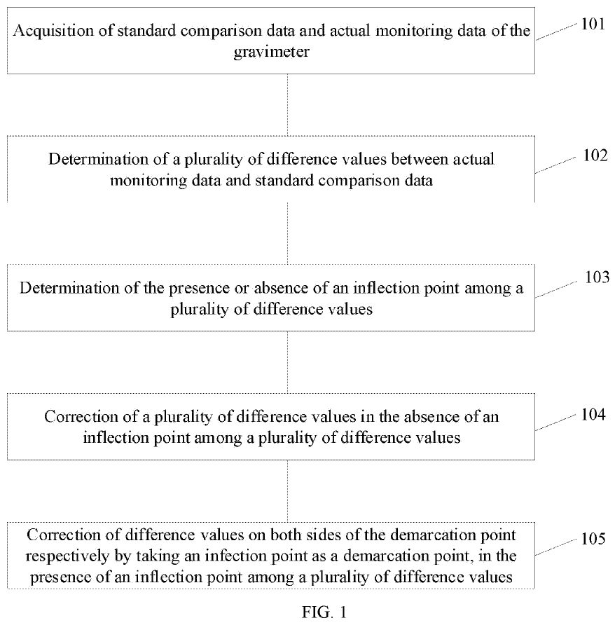

Referring to FIG. 1, a flow chart of the gravimeter correction method provided by examples of the present application is illustrated, as shown in FIG. 1, the correction method includes:
step 101: acquiring standard comparison data and actual monitoring data of the gravimeter.

Generally, for marine gravity measurement, a dock gravity base point comparison measurement must be performed before sailing and after docking. The difference value between the gravimeter reading acquired from the gravity base point comparison measurement of the gravity's first leaving from the dock and the last returns to the dock, is the amount of zero drift during this measurement, also known as zero drift. While the purpose of zero drift correction is to distribute the zero drift equally to each gravity recording point, so that the error is deducted from the gravimeter reading at each recording point.

In addition, the gravimeter will show a reading when the ship departs from the dock, and will show a reading while the ship is in motion, and will still have a reading after the ship docks, i. e., the gravimeter can always conduct monitoring and show a reading during the period from the time the ship departs from the dock to the time the ship returns to the dock. Data monitored by the gravimeter while the ship is in motion is actual monitoring data of the gravimeter.

In addition, in examples of the present application, actual monitoring data of the gravimeter can be acquired by exporting data from the gravimeter on the ship after the ship has finished traveling, and actual monitoring data of the gravimeter can be stored afterwards, and standard comparison data can be stored, so that actual monitoring data of the gravimeter and standard comparison data can be directly acquired when actual monitoring data of the gravimeter is needed.

It should be noted that in examples of the present application, the gravimeter is a Strapdown gravimeter, i. e., examples of the present application perform zero drift correction for the Strapdown gravimeter. In addition, in examples of the present application, standard comparison data can be satellite space gravity data, where satellite space gravity data can be data detected by the satellite, and data detected by the satellite is generally considered to be more accurate.

Step 102: determining a plurality of difference values between actual monitoring data and standard comparison data.

In addition, while the ship is in motion, the ship will pass through multiple locations, and the gravimeter will monitor the gravity at each location, i. e., the gravimeter can monitor the gravity at each location on the route that the ship passes, so that actual monitoring data of the gravimeter will have multiple monitoring values, and each monitoring value corresponds to the coordinates of a location and the recording time at that time. In addition, standard comparison data also has a plurality of standard values.

In some embodiments, step 102 can be implemented by: subtracting standard comparison data from actual monitoring data, i. e., the gravity value at the target coordinates in standard comparison data is subtracted from the gravity value at the target coordinates in actual monitoring data, thereby acquiring the difference value. Where the target coordinate is any one of the plurality of coordinates corresponding to imposed monitoring data.

Step 103: determining the presence or absence of an inflection point among a plurality of difference values.

After acquiring a plurality of difference values, determine the presence or absence of the inflection point among a plurality of difference values, thereby determine whether a plurality of difference values are linearly distributed.

In some embodiments, step 103 can be implemented by: comparing the magnitude of the target difference value and difference values on both sides of the target difference value, and the target difference value is any one of a plurality of difference values except the difference values at two endpoints; if each of the difference values on both sides of the target difference value is greater than or less than the target difference value, there is an inflection point among a plurality of difference values, and the target difference value is the inflection point; if only one of difference values on both sides of the target difference value is greater than the target difference value, and the other difference value is smaller than the target difference value, there is no inflection point among a plurality of difference values.

Where since there are a plurality of difference values, for difference values among a plurality of difference values other than difference values at two endpoints, each of these difference values has adjacent difference values on both sides of the difference values. For example, there are 5 difference values of 0.2, 0.3, 0.4, 0.35, and 0.1, respectively. Difference values at two endpoints are 0.2 and 0.1 respectively, any one of 3 difference values other than difference values at two endpoints have adjacent difference values on both sides, and difference values 0.2 and 0.4 are on either side of the difference value 0.3, and difference values 0.3 and 0.35 are on either side of the difference value 0.4.

In addition, by comparing the magnitude of the target difference value and difference values on both sides of the target difference value, the presence of an inflection point among a plurality of different values can be determined. For example, there are 5 difference values of 0.2, 0.3, 0.4, 0.35, and 0.1, and the target difference value is 0.4, at this time, the magnitude of 0.4 and the two difference values on both sides can be compared, i. e., the magnitude of 0.4 and 0.3 is compared, and the magnitude of 0.4 and 0.35 is compared, leading to the result that 0.4 is greater than 0.3, and 0.4 is greater than 0.35, then 0.4 is an inflection point. For another example, there are 5 difference values of 0.2, 0.3, 0.4, 0.5, and 0.58, and the target difference value is 0.4, at this time, the magnitude of 0.4 and two difference values on both sides can be compared, i. e., the magnitude of 0.4 and 0.3 is compared, and the magnitude of 0.4 and 0.5 is compared, leading to the result that 0.4 is greater than 0.3, and 0.4 is smaller than 0.5, then 0.4 is not an inflection point. In this way, for each target difference value, it is possible to determine the presence or absence of the inflection point among a plurality of difference values.

In addition, in some embodiments, step 103 can be implemented by: a linear fit is performed on a plurality of difference values to acquire a linear fit line, and it is determined whether the slope of the linear fit line changes, and if the slope of the linear fit line changes, there is an inflection point among a plurality of difference values, and if the slope of the linear fit line remains the same, there is no inflection point among a plurality of difference values.

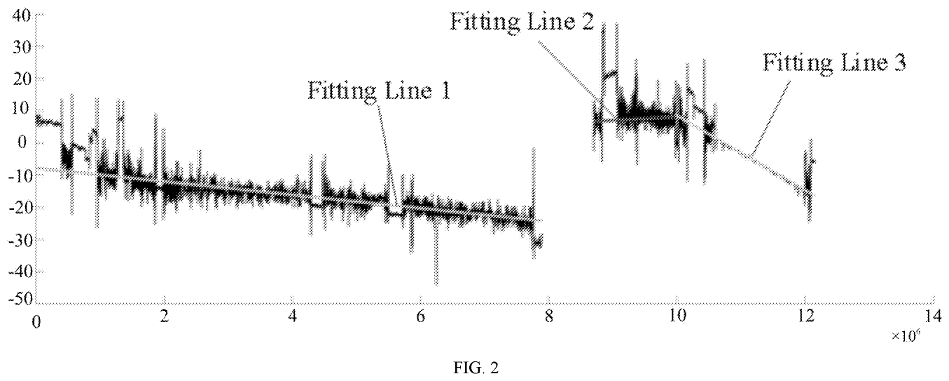

For example, a schematic diagram of the formation of the difference value between actual monitoring data and standard comparison data of the gravimeter is shown in FIG. 2, a linear fit is performed on a plurality of difference values to acquire three fitted lines, which are fitted line 1, fitted line 2 and fitted line 3, the slope of fitted line 2 is K21=1.00E-06, and the slope of fitted line 3 is K22=−1.16E-05, and the slopes of fitted line 2 and fitted line 3 are not equal, indicating a change in the slope of the fitted line, which further indicates the presence of an inflection point among a plurality of difference values. Where the unit of the horizontal coordinate in FIG. 2 is second(s) and the unit of the vertical coordinate is 10⁻⁵ m/s²○

Step 104: correcting a plurality of difference values in the absence of an inflection point among a plurality of difference values.

Correcting a plurality of difference values directly in the absence of an inflection point among the plurality of difference values, i. e., the zero-drift correction can be performed directly.

In some embodiments, step 103 can be implemented by: correcting a plurality of difference values according to a correction formula in the absence of an inflection point among a plurality of difference values, and the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value,

K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of pre-measurement base point comparison,

Step 105: correcting difference values on both sides of the demarcation point respectively by taking an infection point as a demarcation point, in the presence of an inflection point among a plurality of difference values;

In some embodiments, step 105 can be implemented by: correcting difference values on both sides of the demarcation point respectively by taking an infection point as a demarcation point, in the presence of the inflection point among a plurality of difference values; correcting a difference value between two infection points by taking each infection point as a demarcation point, in the presence of a plurality of inflection points among a plurality of difference values, and correcting the difference value between the inflection point closest to the endpoints among a plurality of difference values and the endpoints.

For example, there are 5 differences of 0.1, 0.2, 0.3, 0.25, and 0.15, and it is determined that there is only one inflection point, i. e., the inflection point is 0.3. At this point, 0.3 is taken as a demarcation point, so that data can be divided into two segments, with the difference values of 0.1 and 0.2 on one side of the inflection point and 0.25 and 0.15 on the other side, and data on each side of the inflection point is corrected respectively. For another example, there are 7 difference values of 0.1, 0.2, 0.5, 0.4, 0.35, 0.45 and 0.6, and it is determined that there are two inflection points, and the two inflection points are 0.5 and 0.35, respectively. At this time, 0.5 and 0.35 are taken as two demarcation points, and the difference value between the two inflection points is corrected, i. e., 0.4 is corrected, and there are two endpoints among a plurality of difference values, which are 0.1 and 0.15 respectively, with the inflection point closest to 0.1 being 0.5 and the inflection point closest to 0.15 being 0.35, thereby correcting for the difference value between 0.1 and 0.35 and correcting for the difference value between 0.15 and 0.35.

In addition, in some embodiments, the correction for difference values on both sides of the demarcation point can be implemented by: correcting difference values on both sides of the demarcation point respectively according to the correction formula, and the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

In addition, in some embodiments, the correction for the difference value between two inflection points can be implemented by: correcting the difference value between two inflection points according to the correction formula. The correction for a difference value between an inflection point closest to an endpoint among a plurality of difference values and the endpoint can be implemented by: correcting a difference value between an inflection point closest to an endpoint among a plurality of difference values and the endpoint according to the correction formula, and the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

In addition, in some embodiments, a difference value corresponds to a time point, at this time, prior to step 103, the correction method can further include: determining whether a plurality of time points corresponding to a plurality of difference values are continuous; if a plurality of time points are continuous, determining the presence of absence of an inflection point among a plurality of difference values; and if there is an intermittent time period among a plurality of time points, determining the presence of absence of an inflection point for a plurality of difference values on both sides of the intermittent time period respectively.

Where a difference value corresponds to a time point, so that after acquiring a plurality of difference values, it is also equivalent to acquiring a plurality of time points corresponding to a plurality of difference values, thereby it can be determined whether a plurality of time points are continuous. Where time point continuity means that the difference value between two adjacent time points is constant. For example, if 3 time points are 1 second, 2 seconds and 3 seconds respectively, then these 3 time points are continuous. For another example, if 5 time points are 1 second, 2 seconds, 3 seconds, 10 seconds, and 11 seconds, then the 3 time points of 1 second, 2 seconds, and 3 seconds are continuous, the time points of 3 seconds and 10 seconds are not continuous, and there is an intermittent time period between 3 seconds and 10 seconds.

In addition, while the ship is in motion, when the gravimeter is always on, at this time, the time points corresponding to the actual monitoring data of the gravimeter are continuous, when the gravimeter is turned on for a period of time, the gravimeter is turned off, and the gravimeter is turned on again afterwards, so that the gravimeter will not monitor the data during the time period when the gravimeter is turned off, and the intermittent time points will appear in the time points corresponding to the actual monitoring data of the gravimeter eventually. That is, in examples of the present application, the determination of whether a plurality of time points corresponding to a plurality of difference values is continuous is to determine whether the gravimeter is turned off during the process of monitoring.

In addition, in some embodiments, in the presence of an intermittent time period among a plurality of time points, step 105 can be implemented by: standardizing a plurality of difference values on both sides of the intermittent time period so that the standards of a plurality of difference values at both ends of the time period are the same; determining the location of the inflection point relative to the intermittent time period; and if the inflection point is located on the same side of the intermittent time period, the difference values on both sides of the inflection point are corrected respectively by taking the inflection point as the demarcation point.

Where the standardizing a plurality of difference values on both sides of the intermittent time period can be implemented by: linearly fitting a plurality of difference values on both sides of the intermittent time period respectively to acquire a plurality of fitted straight lines, determining the fitted straight line where an initial time point is located, and adjusting the standards of the fitted straight lines other than the fitted straight line where an initial time point is located to the standard of the fitted straight line where the initial time point is located.

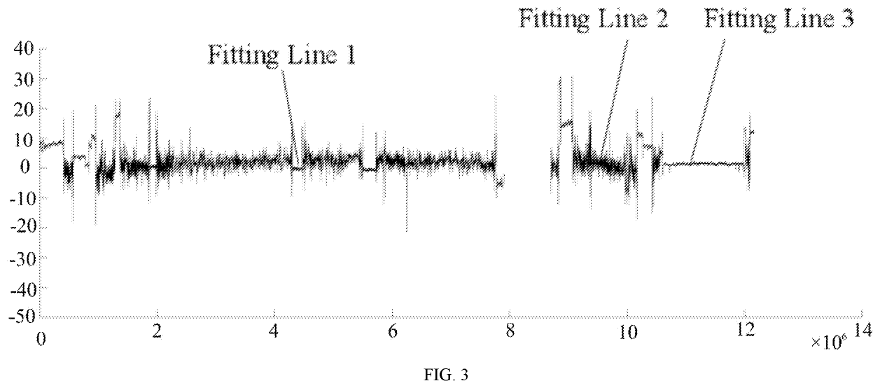

For example, as shown in FIG. 2, the fitted straight line 1 is the fitted straight line where the initial time point is located, and the fitted straight line 2 and the fitted straight line 3 are two other fitted straight lines other than the fitted straight line where the initial time point is located, and the standard of the fitted straight line 2 and the standard of the fitted straight line 3 are adjusted, i. e., the fitted straight line 2 is shifted down and the fitted straight line 3 is shifted down, to acquire the graph shown in FIG. 3. When shifting down the fitted straight line 2, the downward shift is the difference value between an intersection point of an extension line of the fitted straight line 2 and the vertical coordinate and a zero point, where the zero point is an intersection point of the fitted straight line 1 and the vertical coordinate. When shifting down the fitted straight line 3, the downward shift is the difference value between an intersection point of an extension line of the fitted straight line 3 and the vertical coordinate and a zero point, where the zero point is an intersection point of the fitted straight line 1 and the vertical coordinate. Where the unit of the horizontal coordinate in FIG. 3 is second(s) and the unit of the vertical coordinate is 10⁻⁵ m/s²○

In addition, after acquiring a plurality of time points and after determining the inflection point and the intermittent time period, the location of the inflection point relative to the intermittent time period can be determined. If the inflection points are on the same side of the intermittent time period, i. e., all the inflection points are on the same side of the intermittent time period, then the difference values on two sides of the inflection points are corrected by taking the inflection point as the demarcation point, and the difference value between one inflection point closest to the intermittent time period and one of the endpoints of the intermittent time period is corrected. If the inflection points are located on both sides of the intermittent time period, then the difference values on two sides of the inflection points is corrected by taking the inflection points on both sides of the interrupted time period as the demarcation points, and the difference value between the inflection point closest to the intermittent time period and one of the endpoints of the intermittent time period is corrected, and both ends of the intermittent time period are processed in this manner.

For example, if there are 10 difference values, corresponding to 10 time points respectively, and the 10 difference values are 0.1, 0.2, 0.3, 0.35, 0.4, 0.32, 0.28, 0.36, 0.43, 0.5, and the 10 time points are 1 second, 2 seconds, 3 seconds, 4 seconds, 5 seconds, 7 seconds, 8 seconds, 9 seconds, 10 seconds, 11 seconds, then the scope of the intermittent time period is between 5 seconds and 7 seconds, the inflection points are 0.4 and 0.28, with 0.4 located on one side of the intermittent time period and 0.28 located on the other side of the intermittent time period, and the difference value on two sides of 0.4 is corrected with 0.4 taken as the inflection point, and the difference value on two sides of 0.28 is corrected with 0.28 taken as the inflection point. Specifically, with 0.4 taken as the inflection point, the difference values of 0.1, 0.2, 0.3, 0.35, and 0.4 are corrected, and the difference values of 0.4 and 0.32 are corrected, and with 0.28 taken as the inflection point, the difference values of 0.32 and 0.28 are corrected, and the difference values of 0.28, 0.36, 0.43, and 0.5 are corrected.

In examples of the present application, acquire standard comparison data and actual monitoring data of the gravimeter, determine a plurality of difference values between actual monitoring data and standard comparison data, determine the presence or absence of an inflection point among a plurality of difference values, correct a plurality of difference values in the absence of an inflection point among a plurality of difference values, correct difference values on both sides of a demarcation point respectively by taking an infection point as a demarcation point in the presence of an inflection point among a plurality of difference values. That is, in examples of the present application, by acquiring actual monitoring data of the gravimeter, determine a plurality of difference values between actual monitoring data and standard comparison data afterwards, and determine the presence or absence of an inflection point among a plurality of difference values, and correct difference values on both sides of a demarcation point respectively by taking an infection point as a demarcation point in the presence of an inflection point to implement more accurate zero drift correction for a gravimeter.

According to the gravimeter zero-drift correction method provided in examples of the present application, the execution subject can be a gravimeter zero-drift correction apparatus. According to examples of the present application, the gravimeter zero-drift correction apparatus provided in examples of the present application is illustrated by examples of the method for performing zero-drift correction for gravimeter by gravimeter zero-drift correction apparatus.

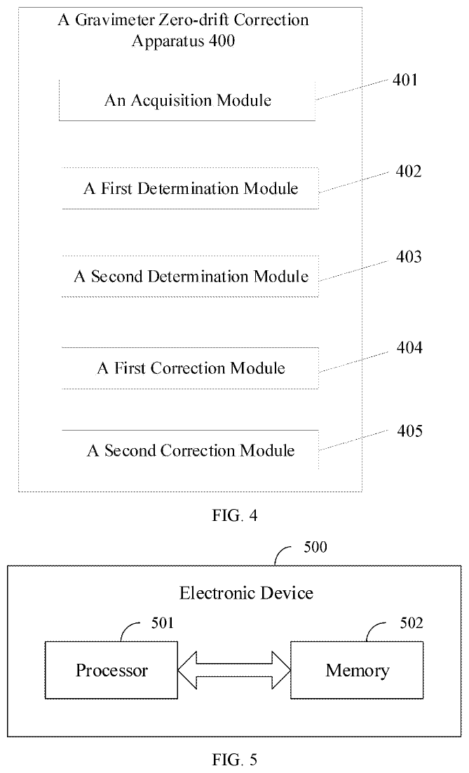

Referring to FIG. 4, a schematic diagram of a gravimeter zero-drift correction apparatus provided by examples of the present application is illustrated, as shown in FIG. 4, the correction apparatus 400 includes:
an acquisition module 401, configured to acquire standard comparison data and actual monitoring data of a gravimeter;
a first determination module 402, configured to determine a plurality of difference values between actual monitoring data and standard comparison data;
a second determination module 403, configured to determine the presence and absence of an inflection point among the plurality of difference values;
a first correction module 404, configured to correct the plurality of difference values in the absence of an inflection point among the plurality of difference values; and
a second correction module 405, configured to correct difference values on both sides of the demarcation point respectively in the presence of an inflection point among the plurality of the difference values.

Optionally, the second determination module, including:
a comparison unit, configured to compare the magnitude of a target difference value and difference values on both sides of a target difference value, where the target difference value is any difference value among a plurality of difference values other than the difference value at two endpoints;
a first determination unit, for the case that if each of difference values on both sides of the target difference value is greater than or less than the target difference value, there is an inflection point among a plurality of the difference values and the target difference value is an inflection point;
a second determination unit, for the case that if only one of difference values on both sides of the target difference value is greater than the target difference value and the other difference value is less than the target difference value, there is no inflection point among a plurality of the difference values.

Optionally, the first correction module, configured to:
Correct the plurality of difference values according to a correction formula in the absence of an inflection point among the difference values, where the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, the second correction module, configured to:
correcting difference values on both sides of the demarcation point respectively in the presence of an inflection point among a plurality of the difference values;
correcting a difference value between the two infection points by taking each infection point as a demarcation point, in the presence of a plurality of inflection points among a plurality of the difference values, and correcting a difference value between an inflection point closest to an endpoint among a plurality of the difference values and the endpoint.

Optionally, a second correction module, configured to:
Correcting difference values on both sides of the demarcation point respectively according to a correction formula, wherein the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, the second correction module, configured to:
correct a difference value between the inflection point according to a correction formula;
the correcting a difference value between an inflection point closest to an endpoint among a plurality of the difference values and the endpoint, including:
correcting a difference value between an inflection point closest to an endpoint among a plurality of the difference values and the endpoint according to a correction formula, where the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, the difference value corresponds to a time point, and the correction apparatus further includes:
a third determination module, configured to determine whether a plurality of time points corresponding to the plurality of difference values are continuous;
a fourth determination module, configured to determine the presence or absence of an inflection point among the plurality of difference values in a case that the plurality of time points are continuous;
a fifth determination module, configured to determine the presence or absence of an inflection point for the plurality of difference values on both sides of the intermittent time period.

Optionally, in the presence of an intermittent time period among the plurality of time points, the second correction module, configured to:
standardize a plurality of difference values on both sides of the intermittent time period so that standards for a plurality of difference values at both ends of the time period are the same;
determine location of the inflection point relative to the intermittent time period;

In a case that the inflection point is located on the same side of the intermittent time period, correct difference values on both sides of the inflection point by taking the inflection point as a demarcation point.

In examples of the present application, acquire standard comparison data and actual monitoring data of the gravimeter, determine a plurality of difference values between actual monitoring data and standard comparison data, determine the presence or absence of an inflection point among a plurality of difference values, correct a plurality of difference values in the absence of an inflection point among a plurality of difference values, correct difference values on both sides of a demarcation point respectively by taking an infection point as a demarcation point in the presence of an inflection point among a plurality of difference values. That is, in examples of the present application, by acquiring actual monitoring data of the gravimeter, determine a plurality of difference values between actual monitoring data and standard comparison data afterwards, and determine the presence or absence of an inflection point among a plurality of difference values, and correct difference values on both sides of a demarcation point respectively by taking an infection point as a demarcation point in the presence of an inflection point to implement more accurate zero drift correction for a gravimeter.

The gravimeter zero-drift correction device provided in examples of the present application can be an electronic device or a component in an electronic device, such as an integrated circuit or a chip. The electronic device can be a terminal, or can be a device other than a terminal. Exemplarily, the electronic device can be a cell phone, a tablet computer, a laptop computer, a handheld computer, a vehicle electronic device, a mobile Internet device (MID), an augmented reality (AR)/virtual reality (VR) device, a robot, a wearable device, an ultra-mobile personal computer (UMPC), a netbook or a personal digital assistant (PDA), etc., further can be a server, a network attached storage (NAS), a personal computer (PC), a television (TV), a teller machine or a self-service machine, etc., without specific limitation in examples of the present application.

The gravimeter zero-drift correction apparatus provided in examples of the present application can be an apparatus with an operating system. The operating system can be Android (Android) operating system, can be ios operating system, and further can be other possible operating system, without specific limitation in examples of the present application.

The gravimeter zero-drift correction apparatus provided in examples of the present application is capable of implementing various processes implemented by examples of the method in FIG. 1, which will not be repeated herein to avoid repetition.

Optionally, as shown in FIG. 5, examples of the present application also provide an electronic device 500, including a processor 501 and a memory 502, and a memory 502 stores a program or an instruction runnable on the processor 501, and various steps of examples of the above mentioned gravimeter zero drift correction method are implemented when the program or instruction is executed by a processor 501 to achieve the same technical effect, which will not be repeated herein to avoid repetition.

It should be noted that the electronic device provided in examples of the present application include the above mentioned mobile electronic device and non-mobile electronic device.

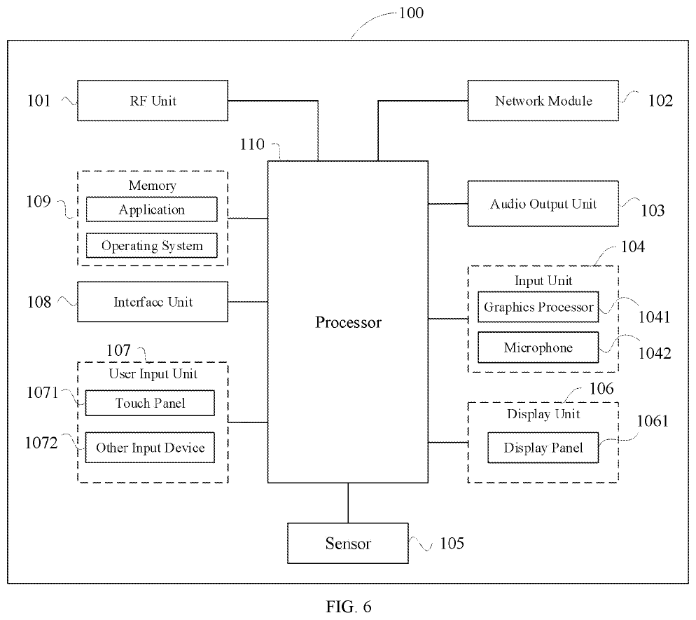

FIG. 6 is a schematic diagram of a hardware structure of an electronic device that implements examples of the present application.

The electronic device 100 includes, but is not limited to: components such as an RF unit 101, a network module 102, an audio output unit 103, an input unit 104, a sensor 105, a display unit 106, a user input unit 107, an interface unit 108, a memory 109, and a processor 110, etc.

It should be understood by person skilled in the art that an electronic device 100 further includes a power supply (e.g., a battery) to power various components, and a power supply can be logically connected to a processor 110 through a power management system so that functions such as charge management, discharge management, and power consumption management can be achieved through the power management system. The electronic device structure illustrated in FIG. 6 does not constitute a limitation of the electronic device, which can include more or fewer components than that illustrated in FIG. 6, or a combination of certain components, or a different arrangement of components, which will not be repeated herein.

Where the processor 110 is configured to acquire standard comparison data and actual monitoring data of the gravimeter, determine a plurality of difference values between actual monitoring data and standard comparison data, determine the presence or absence of an inflection point among a plurality of difference values, correct a plurality of difference values in the absence of an inflection point among a plurality of difference values, correct difference values on both sides of a demarcation point respectively by taking an infection point as a demarcation point in the presence of an inflection point among a plurality of difference values.

In examples of the present application, acquire standard comparison data and actual monitoring data of the gravimeter, determine a plurality of difference values between actual monitoring data and standard comparison data, determine the presence or absence of an inflection point among a plurality of difference values, correct a plurality of difference values in the absence of an inflection point among a plurality of difference values, correct difference values on both sides of a demarcation point respectively by taking an infection point as a demarcation point in the presence of an inflection point among a plurality of difference values. That is, in examples of the present application, by acquiring actual monitoring data of the gravimeter, determine a plurality of difference values between actual monitoring data and standard comparison data afterwards, and determine the presence or absence of an inflection point among a plurality of difference values, and correct difference values on both sides of a demarcation point respectively by taking an infection point as a demarcation point in the presence of an inflection point to implement more accurate zero drift correction for a gravimeter.

Optionally, a processor 110, further configured to: compare the magnitude of the target difference value and difference values on both sides of the target difference value, and the target difference value is any one of a plurality of difference values except difference values at two endpoints; if each of difference values on both sides of the target difference value is greater than or less than the target difference value, there is an inflection point among a plurality of difference values, and the target difference value is the inflection point; if only one of the difference values on both sides of the target difference value is greater than the target difference value, and the other difference value is smaller than the target difference value, there is no inflection point among a plurality of difference values.

Optionally, a processor 110, further configured to: correct a plurality of difference values in the absence of an inflection point among a plurality of difference values, including:
correcting a plurality of difference values according to a correction formula in the absence of an inflection point among a plurality of difference values, where the correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, a processor 110, further configured to: correct difference values on both sides of the demarcation point respectively by taking an infection point as a demarcation point, in the presence of an inflection point among a plurality of difference values, including:
correcting difference values on both sides of the demarcation point respectively by taking an infection point as a demarcation point, in the presence of an inflection point among a plurality of difference values;
correcting a difference value between two infection points by taking each infection point as a demarcation point, in the presence of a plurality of inflection points among a plurality of difference values, and correct a difference value between an inflection point closest to an endpoint among a plurality of difference values and the endpoint.

Optionally, a processor 110, further configured to: correct difference values on both sides of the demarcation point respectively according to a correction formula, and a correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, a processor 110, further configured to: correct a difference value between two inflection points according to a correction formula;

Optionally, a processor 110, further configured to: correct a difference value between an inflection point closest to an endpoint among a plurality of the difference values and the endpoint according to a correction formula, and a correction formula is

$$\\ {δ}_{gk} = - K \frac{{S}_{2} - {S}_{1}}{{t}_{2} - {t}_{1}} ( t - {t}_{1} ) ;$$

where δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

Optionally, a processor 110, further configured to: determine whether a plurality of time points corresponding to a plurality of difference values are continuous; if a plurality of time points are continuous, determine the presence of absence of an inflection point among a plurality of difference values; and if there is an intermittent time period among a plurality of time points, determine the presence or absence of the inflection point for a plurality of difference values on both sides of the intermittent time period respectively.

Optionally, in the presence of an intermittent time period among a plurality of time points, a processor 110, further configured to: standardize a plurality of difference values on both sides of the intermittent time period so that standards of a plurality of difference values at both ends of the time period are the same; determine the location of the inflection point relative to the intermittent time period; and if the inflection point is located on the same side of the intermittent time period, the difference values on both sides of the inflection point are corrected respectively by taking the inflection point as the demarcation point.

In examples of the present application, acquire standard comparison data and actual monitoring data of the gravimeter, determine a plurality of difference values between actual monitoring data and standard comparison data, determine the presence or absence of an inflection point among a plurality of difference values, correct a plurality of difference values in the absence of an inflection point among a plurality of difference values, correct difference values on both sides of a demarcation point respectively by taking an infection point as a demarcation point in the presence of an inflection point among a plurality of difference values. That is, in examples of the present application, by acquiring actual monitoring data of the gravimeter, determine a plurality of difference values between actual monitoring data and standard comparison data afterwards, and determine the presence or absence of an inflection point among a plurality of difference values, and correct difference values on both sides of a demarcation point respectively by taking an infection point as a demarcation point in the presence of an inflection point to implement more accurate zero drift correction for a gravimeter.

It should be understood that in examples of the present application, an input unit 104 can include a graphics processing unit (GPU) 1041 and a microphone 1042, and a graphics processor 1041 processes image data of a still picture or video obtained by an image capture device (such as a camera) in video capture mode or image capture mode. A display unit 106 can include a display panel 1061, and a display panel 1061 can be configured in the form of a liquid crystal display, an organic light-emitting diode, etc. An user input unit 107 includes at least one of a touch panel 1071 and other input device 1072. A touch panel 1071, also known as a touch screen. A touch panel 1071 can include two parts: a touch monitoring device and a touch controller. Other input device 1072 can include, but are not limited to, physical keyboard, a function key (e.g., volume control button, switch button, etc.), trackball, mice, and joystick, which will not repeated herein.

A memory 109 can be used to store software program as well as various data. A memory 109 can primarily include a first storage area for storing program or instruction and a second storage area for storing data, where the first storage area can store operating system and application or instruction required for at least one function (e.g., sound playback function, image playback function, etc.), etc. In addition, a memory 109 can include a volatile memory or a non-volatile memory, or, a memory x09 can include both volatile and non-volatile memory. Where the non-volatile memory can be read-only memory (Read-Only Memory, ROM), programmable read-only memory (Programmable ROM, PROM), erasable programmable read-only memory (Erasable PROM, EPROM), electrically erasable programmable read-only memory (Electrically EPROM, EEPROM) or flash memory. The volatile memory can be random access memory (Random Access Memory, RAM), static random access memory (Static RAM, SRAM), dynamic random access memory (Dynamic RAM, DRAM), synchronous dynamic random access memory (Synchronous DRAM, SDRAM), double data rate synchronous dynamic random access memory (Double Data Rate SDRAM, DDRSDRAM), enhanced synchronous dynamic random access memory (Enhanced SDRAM, ESDRAM), synchronous link dynamic random access memory (Synch link DRAM, SLDRAM), and direct memory bus random access memory (Direct Rambus RAM, DRRAM). The memory 109 provided in examples of the present application includes, but is not limited to, these and any other suitable type of memory.

A processor 110 can include one or more processing unit; optionally, a processor 110 integrates an application processor and a modem processor, where the application processor primarily disposes operation involving an operating system, an user interface, an application, etc., and the modem processor primarily disposes a wireless communication signal, such as a baseband processor. It should be understood that the modem processor mentioned above can also skip being integrated into the processor 110.

Examples of the present application further provide a readable storage medium, where the readable storage medium stores a program or an instruction, and various processes of examples of the above mentioned gravimeter zero drift correction method are implemented when the program or instruction is executed by the processor to achieve the same technical effect, which will not be repeated herein to avoid repetition.

Where the processor is a processor in the electronic device according to the above mentioned example. The readable storage media includes a computer-readable storage media, such as a computer read-only memory ROM, a random access memory RAM, a disk or a CD-ROM, etc.

Examples of the present application further provide a chip, where the chip includes a processor and a communication interface, where the communication interface is coupled with the processor, and the processor is used to run a program or an instruction to implement various processes of examples of the above mentioned gravimeter zero drift correction method to achieve the same technical effect, which will not be repeated herein to avoid repetition.

It should be understood that the chip mentioned in examples of the present application can further be referred to as a system level chip, system on chip, chip system, or system-on-a-chip, etc.

Examples of the present application provide a computer program product, where the program product is stored in a storage medium, and the program product is executed by at least one processor to implement various processes of examples of the above mentioned gravimeter zero drift correction method to achieve the same technical effect, which will not be repeated herein to avoid repetition.

It is noted that the terms “include”, “comprise”, or any other variation thereof described herein are intended to cover non-exclusive inclusion such that a process, method, article, or apparatus including a set of elements includes not only those elements, but also other elements not expressly listed, or which are inherent to such process, method, article, or apparatus. Without further limitation, an element defined by the statement “including a(an) . . . ” does not preclude the presence of another identical element in the process, method, article, or apparatus that includes such element. In addition, it is noted that the scope of the method and apparatus provided in embodiments of the present application is not limited to performing the function depending on the shown or discussed order, and further includes performing the function in a substantially simultaneous manner or in an reverse order depending on the involved function, for example, the described method can be performed in an order different than that described, and various steps can be added, omitted, or combined. In addition, feature described with reference to some examples can be combined in other example.

According to the description of above embodiments, it will be clear to person skilled in the art that the method of the example mentioned above can be implemented with a combination of the software and the necessary common hardware platform, or of course with hardware alone, but preferably the former in many cases. Based on such understanding, the technical solution of the present application, in essence, or the part that contributes to the prior art, can be embodied in the form of a computer software product and the computer software product is stored in a storage medium (e.g., ROM/RAM, disk, CD-ROM), and a plurality of instructions are included to enable a terminal (which can be a cell phone, a computer, a server, or a network device, etc.) to implement the method described in various examples of the present application.

Examples of the present application are described above in conjunction with the drawings, but the present application is not limited to the above specific embodiments, and the above specific embodiments are merely schematic and not limiting, and there are many other forms that can be made by an ordinary person skilled in the art under the inspiration of the present application, without departing from the scope of protection of the purpose and claims of the present application, all of which fall within the protection of the present application.

1. A gravimeter zero-drift correction method, characterized in that the correction method comprises:
acquiring standard comparison data as well as actual monitoring data of a gravimeter;
determining a plurality of difference values between the actual monitoring data and the standard comparison data;
determining the presence or absence of an inflection point among the plurality of difference values;
correcting the plurality of difference values in the absence of an inflection point among the plurality of difference values; and
correcting a difference value on both sides of the demarcation point respectively in the presence of an inflection point among the plurality of the difference values.

2. The gravimeter zero-drift correction method according to claim 1, characterized in that the determining the presence or absence of an inflection point among the plurality of difference values, comprising:
comparing the magnitude of a target difference value and difference values on both sides of the target difference value, wherein the target difference value is any difference value among the plurality of difference values other than the difference values at two endpoints;
if difference values on both sides of the target difference is greater than or less than the target difference, there is an inflection point among a plurality of the difference values and the target difference is an inflection point;
if only one of difference values on both sides of the target difference value is greater than the target difference value and the other difference value is less than the target difference value, there is no inflection point among a plurality of the difference values.

3. The gravimeter zero-drift correction method according to claim 1, characterized in that, correcting the plurality of difference values in the absence of an inflection point among the plurality of difference values, comprising:
Correcting the plurality of difference values according to a correction formula in the absence of an inflection point among the plurality of difference values, wherein the correction formula is
$$\\ {δ}_{gk} = - K \frac{{S}_{2} - {S}_{1}}{{t}_{2} - {t}_{1}} ( t - {t}_{1} ) ;$$
wherein δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

4. The gravimeter zero-drift correction method according to claim 1, characterized in that, the correcting difference values on both sides of the demarcation point respectively by taking the infection point as a demarcation point, in the presence of an inflection point among the plurality of difference values, comprising:
correcting difference values on both sides of the demarcation point respectively by taking the infection point as a demarcation point, in the presence of an inflection point among the plurality of difference values;
correcting a difference value between the two infection points by taking each infection point as a demarcation point, in the presence of a plurality of inflection points among the plurality of difference values, and correcting a difference value between an inflection point closest to an endpoint among a plurality of the difference values and the endpoint.

5. The gravimeter zero-drift correction method according to claim 4, characterized in that, the correcting difference values on both sides of the demarcation point respectively, comprising:
Correcting difference values on both sides of the demarcation point respectively according to a correction formula, wherein the correction formula is
$$\\ {δ}_{gk} = - K \frac{{S}_{2} - {S}_{1}}{{t}_{2} - {t}_{1}} ( t - {t}_{1} ) ;$$
wherein δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

6. The gravimeter zero-drift correction method according to claim 4, characterized in that, the correcting a difference value between the two inflection points, comprising:
correcting a difference value between the two inflection points according to a correction formula;
the correcting a difference value between an inflection point closest to an endpoint among a plurality of the difference values and the endpoint, comprising:
correcting a difference value between an inflection point closest to an endpoint among a plurality of the difference values and the endpoint according to a correction formula, wherein the correction formula is
$$\\ {δ}_{gk} = - K \frac{{S}_{2} - {S}_{1}}{{t}_{2} - {t}_{1}} ( t - {t}_{1} ) ;$$
wherein δ_{gk} indicates a gravimeter zero drift correction value, K indicates a gravimeter grid value, S₂ indicates a gravimeter reading during post-measurement base point comparison, S₁ indicates a gravimeter reading during pre-measurement base point comparison, t₂ indicates the time of pre-measurement base point comparison, t₁ indicates the time of pre-measurement base point comparison, t indicates the time of a measurement point.

7. The gravimeter zero-drift correction method according to claim 1, characterized in that, the difference value corresponds to a time point, and before determining the presence or absence of an inflection point among the plurality of difference values, the correction method further comprises:
determining whether a plurality of time points corresponding to the plurality of difference values are continuous;
determining the presence or absence of an inflection point among the plurality of difference values in a case that the plurality of time points are continuous;
determining the presence or absence of an inflection point for the plurality of difference values on both sides of the intermittent time period in the presence of an intermittent time period among the plurality of time points.

8. The gravimeter zero-drift correction method according to claim 7, characterized in that, in the presence of an intermittent time period among the plurality of time points, the correcting difference values on both sides of the demarcation point respectively by taking the infection point as a demarcation point, in the presence of an inflection point among the plurality of the difference values, comprising:
standardizing a plurality of difference values on both sides of the intermittent time period so that standards for a plurality of difference values at both ends of the time period are the same;
determining location of the inflection point relative to the intermittent time period;
In a case that the inflection point is located on the same side of the intermittent time period, correcting difference values on both sides of the inflection point by taking the inflection point as a demarcation point.

9. A gravimeter zero-drift correction apparatus, characterized in that, the correction apparatus comprises:
an acquisition module, configured to acquire standard comparison data and actual monitoring data of a gravimeter;
a first determination module, configured to determine a plurality of difference values between the actual monitoring data and the standard comparison data;
a second determination module, configured to determine the presence or absence of an inflection point among the plurality of difference values;
a first correction module, configured to correct the plurality of difference values in the absence of an inflection point among the plurality of difference values; and
a second correction module, configured to correct difference values on both sides of the demarcation point respectively in the presence of an inflection point among the plurality of the difference values.

10. An electronic device, characterized in that, the electronic device comprises a processor and a memory, wherein the memory stores a program or an instruction runnable on the processor, wherein the step of the gravimeter zero-drift correction method according to claim 1 is implemented when the program or the instruction is executed by the processor.
